(19) United States
(12) Patent Application Publication
(10) Pub. No.: US 2012/0263554 A1
(43) Pub. Date: Oct. 18, 2012

(54) SELF-ALIGNING COUPLING FOR LIFT GUIDES

(75) Inventor: Jesus SANZ GAMBOA, Vera De Bidasoa (Navarra) (ES)

(73) Assignee: S.A. DE VERA (SAVERA), VERA DE BIDASOA (Navarra) (ES)

(21) Appl. No.: 13/440,778

(22) Filed: Apr. 5, 2012

(30) Foreign Application Priority Data
Apr. 18, 2011 (ES) P201130614

(51) Int. Cl. F16B 1/00

(52) U.S. Cl. 411/81

(57) ABSTRACT

A self-aligning coupling for lift guides, which consists of a core-mushroom element and wings. Each wing carries a through hole in its coupling zone and there are:
under the wings an extra-flat plate provided with four through holes in correspondence with the orifices of two guides to be joined;
on top of the wings, two extra-flat plates, each provided with two through holes in correspondence with two orifices of two guides to be joined.
in said orifices, and retaining screws fastened with nuts; said screws presenting a conical head.

The orifices of the plates are of greater diameter than the orifices of the wings.

The distance between the orifices of the plates is shorter than the distance between the two orifices of the wings of the same side.

This invention concerns a coupling system with self-alignment for lift guides.

In the current state of the art, various types of systems are known for coupling of lift guides which tend to self-align said guides. The applicant has developed lift guides with self-aligning couplings of this type and, among other patents, is the owner of Patent ES2320949, which exert lateral pressure of alignment between the guides and their coupling plates.

The self-aligning coupling for lift guides which is the object of the invention supposes a substantial improvement with respect to the known solutions, in that the pressure is generated through auxiliary parts that force the screws to take a specific position. Moreover, this self-aligning coupling, according to the invention, provides other advantages, both from the structural viewpoint (because it improves the mechanical performance) and from the economic viewpoint (because less material is used). It is characterized in that:

a) each wing of the guide is provided with a through hole in its coupling zone;

b) it has a plate under the wings, this plate being of extra-flat configuration and provided with four through holes in positional correspondence with said orifices made in the wings of two guides to be joined;

c) both plates are placed on top of the wings, each plate being of extra-flat configuration and provided with two through holes in positional correspondence with two orifices made in the wings of two guides to be joined;

d) the orifices of said top plates are of greater diameter than the orifices in the wings of the guides;

e) the distance between the orifices of the top plates is shorter than the distance between the two orifices in the wings of the same side that said plate interrelates;

f) there are means of retention in said axially aligned orifices, means that apply pressure and compress the wings of the guides between the upper plates and the lower plate, while, due to the aforementioned differences between diameters and distances, exerting a light frontal pressure on the guides to produce their alignment, because the contact faces are perfectly machined at 90° with respect to the mushroom element of the guide.

In particular, said means of retention are sets of screws and nuts, with or without washers, where the screws present a conical zone under their head; said conical zone enters into contact and is lodged in the orifices of the corresponding upper plate only when the screw is inserted practically in its entirety, at which time the screws of the same side tend to come nearer and a light frontal pressure is generated on the guides, producing their self-alignment.

To better understand the object of this invention, a preferential form of practical embodiment is represented in the drawings, subject to accessory changes that do not essentially alter it.

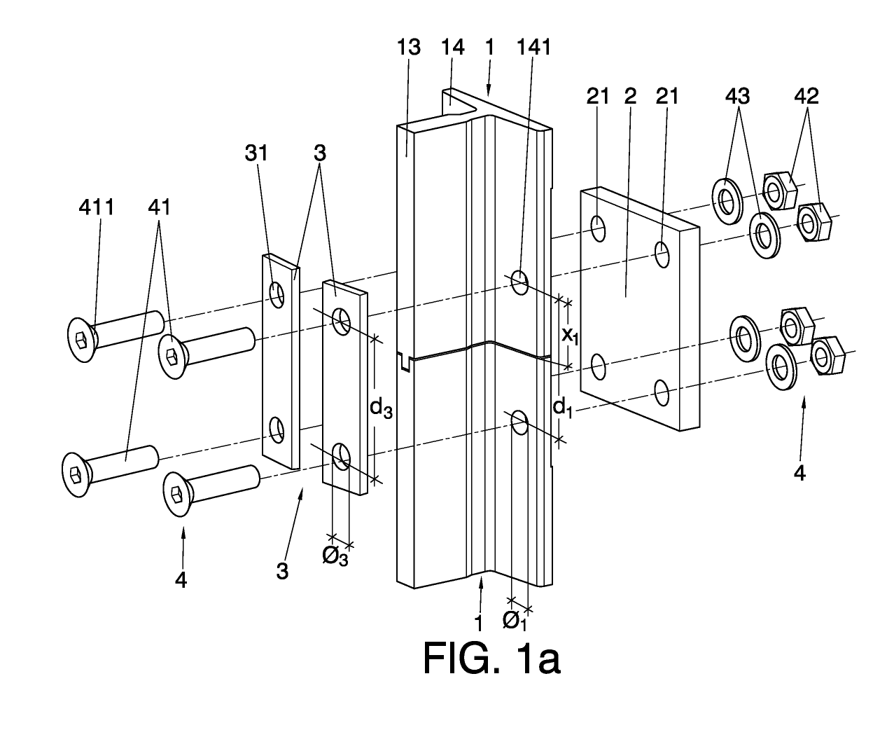

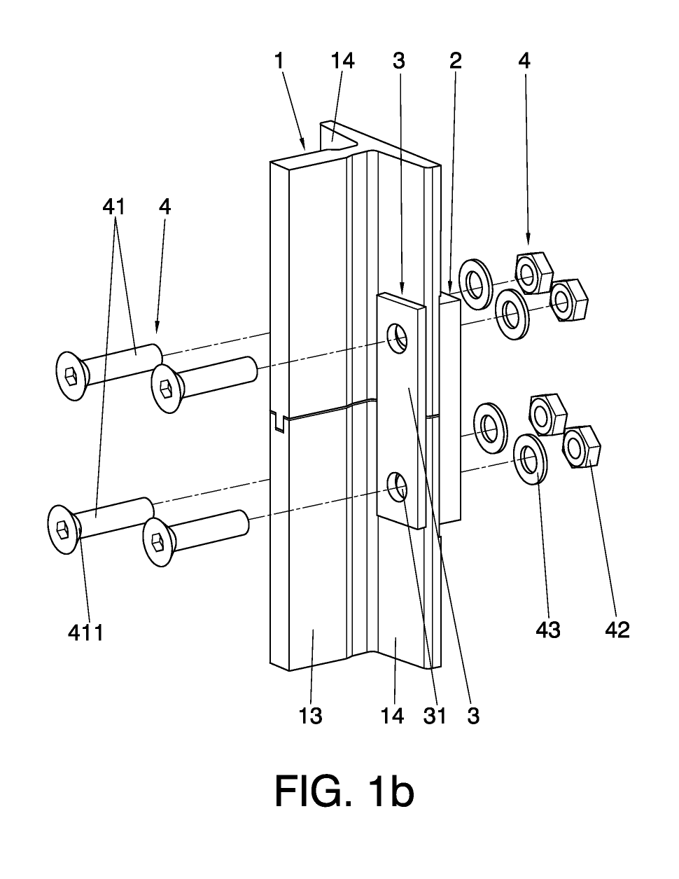

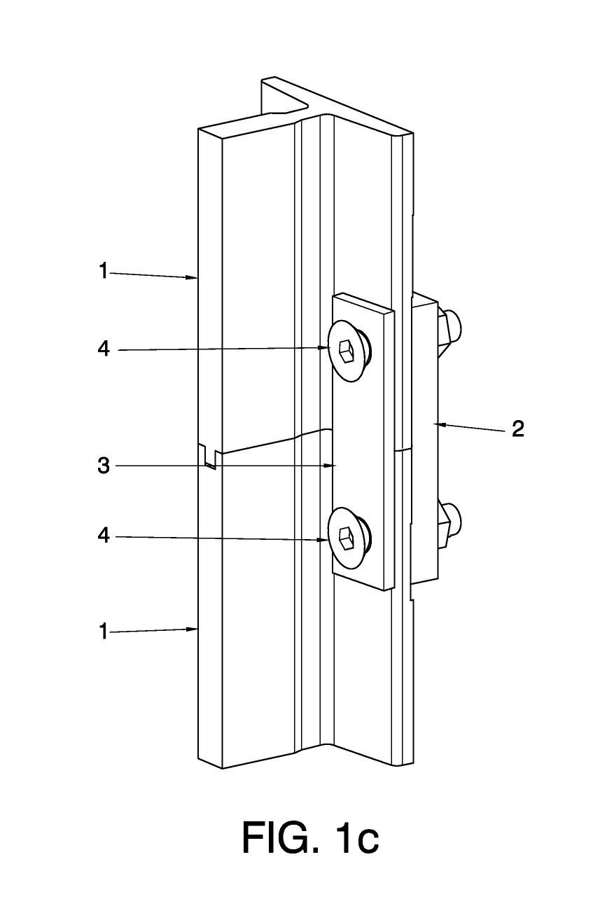

FIG. 1a, 1b and 1c are each general perspective views of the parts composing the self-aligning coupling, according to the invention, in three successive assembly phases.

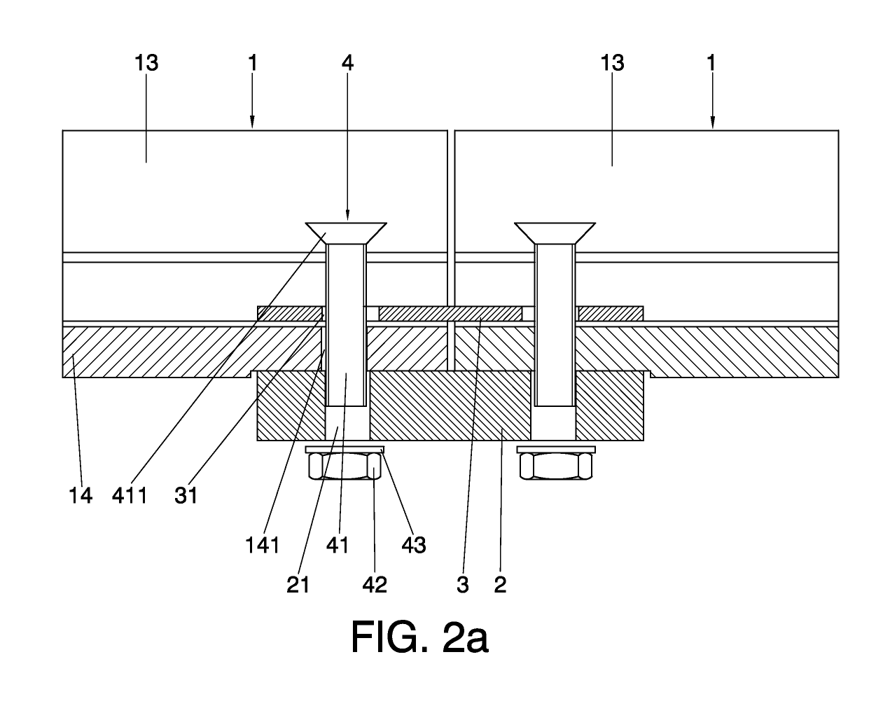

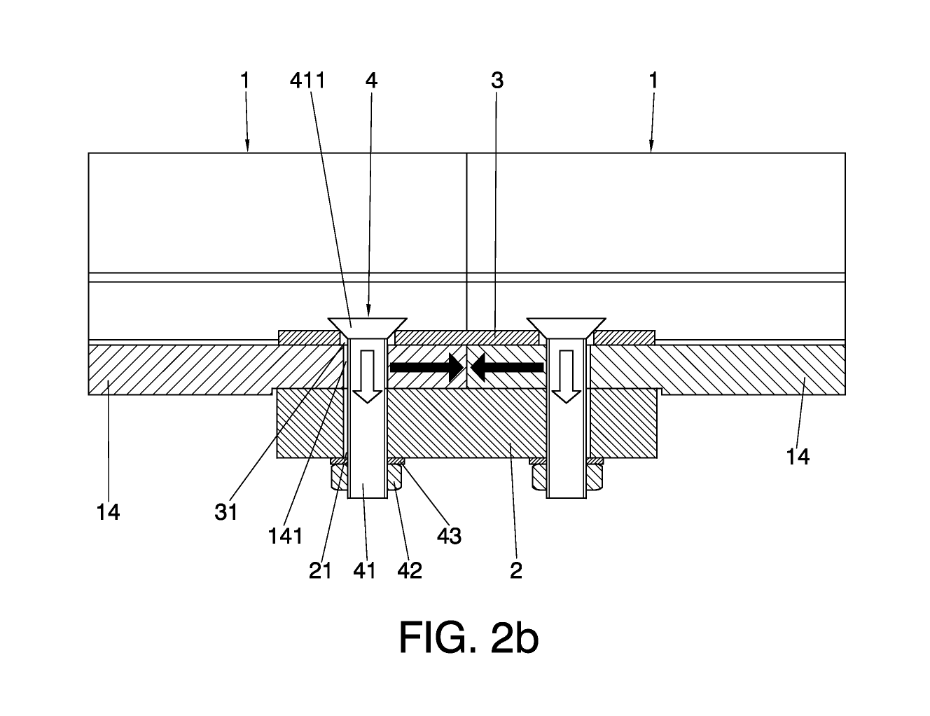

FIGS. 2a and 2b are longitudinal sections, in detail, for the example of embodiment of the foregoing figures in two successive assembly phases:

in FIG. 2a, before inserting the screws (41), the edges of the mushroom element (13) and of the wings (14) are separate;

in FIG. 2b, with the screws (41) inserted, the edges of the mushroom element (13) and of the wings (14) self-align (The vertical forces of the advance of the screws and the horizontal forces that produce the self-alignment have been represented with arrows).

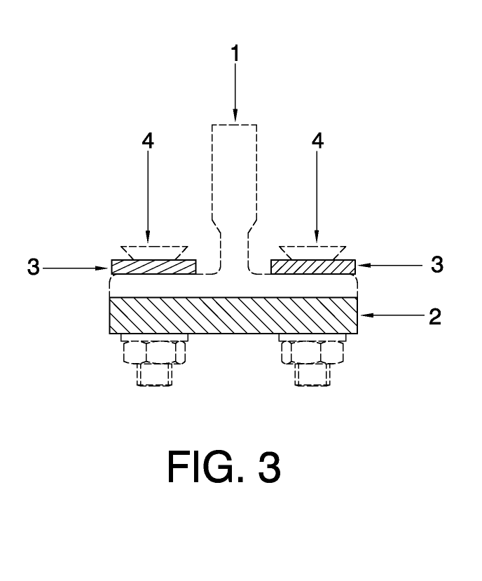

FIG. 3 is a cross-section, in detail, for the example of embodiment of FIGS. 1a, 1b, and 1c.

The following is a description of an example of practical, non-limiting embodiment of this invention.

The coupling with self-alignment for lift guides which is the object of the invention is utilized on guides, (1) of which comprise a core-mushroom element (13) and one wing (14) on each side.

According to the invention, each wing (14) forms in origin, an orifice (141), in its coupling zone; said orifices (141) being placed in opposite pairs, one on each wing (14). Each pair of orifices (141) corresponding to a guide (1) is machined at a pre-set distance; for example, the last of whose pairs is machined at a distance (x₁) from the end of the guide (1)—see FIG. 1a.

According to the invention, there is a plate (2) under the wings (14). This plate (2) is of extra-flat configuration and carries four through holes (21) in positional correspondence with the aforementioned orifices (141) of two guides to be joined; therefore, on said plate (2), the distance between two orifices (21) opposite two orifices (141) of the same side and corresponding to two guides (1) to be joined, will be double the aforementioned distance (x₁); and obviously, the distance between two contiguous orifices (21) will be the same distance as between two orifices (141) made in the two wings (14) of the same guide (1).

According to the invention, there are several plates (3) on the wings (14). Each plate (3) is of extra-flat configuration and carries two through holes (31) in positional correspondence with two orifices (141) made in the wings of two guides (1) to be joined corresponding to the same side; therefore, on each plate (3), the distance between its orifices (31) will be double the aforementioned distance (x₁).

Also fulfilled in the configuration and particulars of the above mentioned components, which comprise the self-aligning coupling, according to the invention:
the orifices (31) of the plates (3) are of greater diameter than the orifices (141) of the wings (14): ₃>₁;
the distance between the orifices (31) of the plates (3) is shorter than the distance between the two orifices (141) of the wings (14) of the same side that said plate interrelates (3): d₃<d₁;

According to the invention, there are means of retention (4) in said orifices (141), (31) and (21) which, due to the differences between diameters ₃>₁ and distances d₃<d₁, apply pressure and compress the wings (14) between the upper plates (3) and the lower plate (2) while exerting a light frontal pressure on the guides (1) to produce their alignment.

In particular, according to the embodiment represented, the aforementioned means of retention (4) are sets of screws (41) and nuts (42), with or without washers (43); where the screws (41) present a conical head (411) which enters into contact and lodges in the orifices (31) of the corresponding upper plate (3) only when the screw (41) is inserted practically in its entirety, at which time they tend to come nearer, producing the self-alignment of the coupling.

1. A self-aligning coupling for lift guides, of the type comprised of core-mushroom element, and wings, where the contact faces are perfectly machined at 90° with respect to the mushroom element of the guide; characterized in that:
a) each wing is provided with a through hole in its coupling zone;
b) there is a plate under the wings; this plate being of extra-flat configuration and provided with four through holes in correspondence with the aforementioned orifices of two guides to be joined;
c) there are two plates on top of the wings; each plate being of extra-flat configuration and provided with two through holes in correspondence with two orifices of two guides to be joined;
d) the orifices of the plates are of greater diameter than the orifices of the wings: ₃>₁;
e) the distance between the orifices of the plates is shorter than the distance between the two orifices of the wings of the same side, which said plate interrelates d₃<d₁;
f) there are means of retention in said orifices and which, due to the differences between diameters ₃>₁ and distances d₃<d₁, apply pressure and compress the wings between the upper plates and the lower plate while exerting a light lateral pressure on the guides to produce their alignment.

2. A self-aligning coupling, according to claim 1, characterized in that the aforementioned means of retention are sets of screws and nuts, with or without washers; where the screws present a conical head which enters into contact and lodges in the orifices of the corresponding upper plate only when the screw is inserted practically in its entirety, at which time the screws of the same side tend to come nearer and a light pressure is generated on the guides, producing their self-alignment.
